(19) United States
(12) Patent Application Publication
(10) Pub. No.: US 2025/0150187 A1
(43) Pub. Date: May 8, 2025

(54) AUDIO PLAYBACK METHOD, BROADCAST DEVICE AND COMPUTER-READABLE STORAGE MEDIUM

(71) Applicant: MediaTek Singapore Pte. Ltd., Singapore (SG)

(72) Inventor: Xinmei TAN, Shenzhen (CN)

(21) Appl. No.: 18/931,179

(22) Filed: Oct. 30, 2024

(30) Foreign Application Priority Data
Nov. 6, 2023 (CN) 202311468235.9

(51) Int. Cl. H04H 20/20; H04H 20/71

(52) U.S. Cl. CPC H04H 20/20; H04H 20/71

(57) ABSTRACT

An audio playback method and device are provided. The audio playback method includes a broadcast device. The broadcast device obtains the audio-to-be-played from a source device via a unicast link. When indicated by the source device to apply a party mode to play the audio-to-be-played, the broadcast device serves as a broadcast media sender and broadcasts the audio-to-be-played to at least one playback device, so as to play the audio-to-be-played through the at least one playback device. This makes a device that only supports traditional unicast functions can also apply the party mode to play the audio-to-be-played.

### CROSS REFERENCE TO RELATED APPLICATIONS

This application claims priority of China Patent Application No. 202311468235.9, filed on Nov. 6, 2023, the entirety of which is incorporated by reference herein.

### BACKGROUND OF THE INVENTION

### Field of the Invention

The present invention relates to the field of audio playback technology, and, in particular, to an audio playback method and device.

### Description of the Related Art

Party mode refers to a scenario where at least two speakers play the same audio content simultaneously. It is a hot selling point in the current speaker market.

One of the audio sources of the party mode comes from end devices such as mobile phones and laptops. As shown in FIG. 1, mobile phones that support the LE audio broadcast media sender (BMS) and speakers that support the broadcast media receiver (BMR) can implement the party mode the BMS-BMR method.

However, most end devices on the market currently support only traditional unicast functions (e.g., A2DP function) and do not support party mode. Therefore, for Bluetooth speakers that only support unicast functions or only support BMR, users cannot apply the party mode through the unicast functions of the Bluetooth speakers when using their mobile phones or computers.

### BRIEF SUMMARY OF THE INVENTION

The present application provides an audio playback method and device, which makes a device that only supports the traditional unicast function to play audio using the party mode.

To achieve the above-mentioned goal, the present application provides an audio playback method. The audio playback method comprises a broadcast device. The broadcast device obtains the audio-to-be-played from a source device via a unicast link. When indicated by the source device to apply a party mode to play the audio-to-be-played, the broadcast device serves as a broadcast media sender and broadcasts the audio-to-be-played to at least one playback device, so as to play the audio-to-be-played through the playback device.

To achieve the above-mentioned goal, the present application further provides a broadcast device comprising a memory and a processor. The memory is coupled to the processor. The processor is configured to execute a program instruction stored in the memory, so as to implement the audio playback method mentioned above.

To achieve the above-mentioned goal, the present application further provides a computer-readable storage medium comprising instruction/program data, wherein the instruction/program data implement the audio playback method mentioned above when executed.

The present application integrates a unicast data-receiving function and the BMS function in the broadcast device, receives the audio-to-be-played from the source device via a unicast link through the unicast data-receiving function, and then broadcasts the audio-to-be-played through the BMS to realize the data conversion between the unicast mode and the broadcast mode. In this way, the party mode is realized between the broadcast device and the playback device receiving the broadcast data through BMS-BMR, so that end devices such as mobile phones and laptops that only support traditional unicast functions can also use the party mode function of the playback device.

### BRIEF DESCRIPTION OF THE DRAWINGS

The drawings described herein are used for providing further understanding of the present application and constituting a part of the present application. The illustrative embodiments of the present application and their descriptions are used for explaining the present application and do not constitute improper limitations on the present application, wherein:

FIG. 1 is a schematic diagram of an audio playback method of the related art;

FIG. 2 is a schematic diagram of an audio playback method of the present application;

FIG. 3 is a flow chart of an embodiment of the audio playback method of the present application;

FIG. 4 is a schematic diagram of data flow in an embodiment of the audio playback method of the present application;

FIG. 5 is a schematic diagram of an agreed-upon playback delay in an embodiment of the audio playback method of the present application;

FIG. 6 is a schematic diagram of the structure of an embodiment of a broadcast device of the present application.

FIG. 7 is a schematic diagram of the structure of an embodiment of a computer-readable storage medium of the present application.

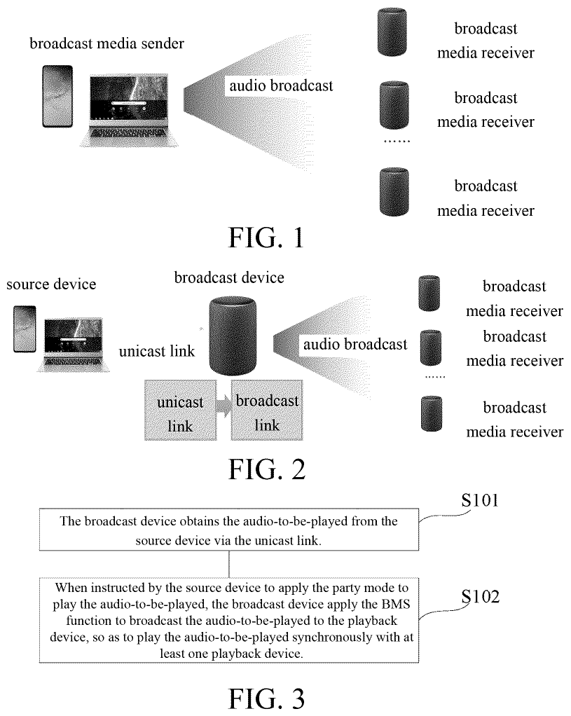

### DETAILED DESCRIPTION OF THE INVENTION

In the following, the technical solutions in the embodiments of the present application will be clearly and completely described with the accompanying drawings in the embodiments of the present application. Obviously, the described embodiments are only a part of the embodiments of the present application, rather than all of the embodiments. Based on the embodiments in the present application, all other embodiments obtained by those of ordinary skill in the art without making creative work are within the scope of the present application. In addition, unless otherwise specified (e.g., “in addition” or “alternatively”), the term “or” herein refers to a non-exclusive “or” (i.e., “and/or”). Moreover, the various embodiments described herein are not necessarily mutually exclusive. Some embodiments can be combined with one or more other embodiments to form new embodiments.

As shown in FIG. 2, the present application proposes a method to integrate a unicast data-receiving function and a Broadcast Media Sender (BMS) function in a broadcast device. The unicast data-receiving function receives audio data from a source node via a unicast link, and the BMS function broadcasts the audio data (e.g., A2DP sink to BMS). In this way, a party mode is implemented between the broadcast device and a playback device that receives broadcast data through BMS-BMR. This makes end devices (e.g., mobile phones and laptops) that support traditional unicast function able to apply the party mode of the playback device.

As shown in FIG. 3, the audio playback method of the present application includes the following steps. Optionally, the audio playback method of the present application may be applied to a broadcast device. The broadcast device may include a playback device such as mobile phone, portable device, headphone, or speaker. In other embodiments, the broadcast device may also be a non-playback device. The non-playback device applying the audio playback method only needs to, in response to an instruction of playing audio in the party mode, broadcast the audio-to-be-played obtained via the unicast link to the playback device through the BMS. It should be noted that the following step numbers are only used for simplifying the description and are not intended to limit the execution order of the steps. The execution order of each step in this embodiment can be changed arbitrarily without violating the technical idea of the present application.
S101: The broadcast device obtains the audio-to-be-played from the source device via the unicast link.

Optionally, the audio-to-be-played can be obtained from the source device via the unicast link first. When receiving an instruction to apply the party mode to play the audio-to-be-played from the source device, the broadcast device can broadcast the audio-to-be-played to the playback devices through its broadcast media audio function (i.e., BMS function). Accordingly, the broadcast device and at least one playback device play the audio-to-be-played synchronously. This realizes the function of playing the audio-to-be-played through the party mode.

Optionally, the source device may be a device without the broadcast media audio function. That is, the source device may not be able to broadcast audio through the broadcast media audio function. In this case, the source device can apply a device with a function of “converting unicast audio to broadcast audio” to broadcast the audio-to-be-played. This achieves the purpose of playing the audio-to-be-played through the party mode.

Of course, in some embodiments, the source device may also be a device with a broadcast media audio function. Nonetheless, the source device may not broadcast the audio-to-be-played through its own broadcast media audio function in its playback mode. Instead, the source device broadcasts the audio-to-be-played through a device with a function of converting unicast audio to broadcast audio. This achieves the purpose of playing the audio-to-be-played through the party mode.

The source device may be a mobile end device, e.g., a mobile phone or a laptop, and is not limited here.

The source device can send the audio-to-be-played to the broadcast device through any unicast link. For example, the source device can send the audio-to-be-played to the broadcast device through a Bluetooth unicast link (e.g., A2DP link), wifi, USB or AirPlay.

When sending the audio-to-be-played or the first frame of the audio-to-be-played, the source device may issue an instruction to the broadcast device to apply the party mode to play the audio-to-be-played. Accordingly, in response to the instruction, the broadcast device broadcasts the audio-to-be-played that is transmitted via the unicast link to the playback device through the broadcast media audio function (i.e., BMS function).

In some implementation scenarios, if the actual purpose of the broadcast device is to convert unicast audio to broadcast audio (i.e., the broadcast device is a broadcaster for other devices), when sending the audio-to-be-played or the first frame of the audio-to-be-played, the source device may not issue an instruction to the broadcast device to play the audio-to-be-played in the party mode. That is, in this implementation scenario, when receiving the audio-to-be-played, the broadcast device automatically broadcasts the audio-to-be-played that is transmitted via the unicast link to the playback device through the broadcast media audio function. That is, when receiving the audio-to-be-played, it is considered as receiving an instruction to play the audio-to-be-played in the party mode.
In S102: When instructed by the source device to apply the party mode to play the audio-to-be-played, the broadcast device serves as a broadcast media sender (BMS) to broadcast the audio-to-be-played to the playback device, so as to play the audio-to-be-played synchronously with at least one playback device.

The broadcast device obtains the audio-to-be-played from the source device via the unicast link. Afterward, when instructed by the source device to apply the party mode to play the audio-to-be-played, the broadcast device broadcasts the audio-to-be-played to the playback device through its broadcast media audio function (i.e., BMS function). Accordingly, the broadcast device and at least one playback device play the audio-to-be-played synchronously. This realizes the function of playing the audio-to-be-played through the party mode.

Optionally, after obtaining the audio-to-be-played, the broadcast device may transmit the audio-to-be-played from a unicast communication module to an audio dispatcher module. Then, it transmits the audio-to-be-played from the audio dispatcher module to the broadcast communication module, so that the broadcast communication module broadcasts the audio-to-be-played to at least one playback device through the broadcast media audio function (i.e., BMS function). The unicast communication module and the broadcast communication module can be two sub-modules of the same communication module (e.g., a Bluetooth communication module). For example, when the unicast communication link in step S101 is a Bluetooth A2DP link, the unicast communication module is an A2DP module in the Bluetooth communication module, and the broadcast communication module is a BMS module in the Bluetooth communication module. Of course, in some embodiments, the unicast communication module and the broadcast communication module may also be different communication modules.

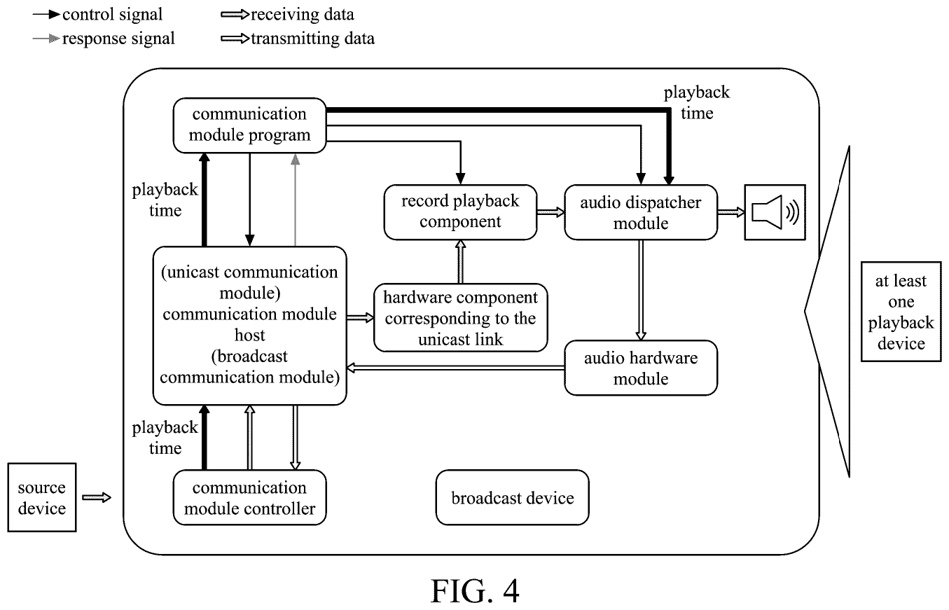

Specifically, as shown in FIG. 4, transmitting the audio-to-be-played from the unicast communication module to the audio dispatcher module may include transmitting the audio-to-be-played to the audio dispatcher module from the unicast communication module and sequentially through a record playback component and a hardware component corresponding to the unicast link. For example, when the unicast link is an Advanced Audio Distribution Profile (A2DP) link, the Bluetooth communication module host can send the audio-to-be-played to the audio dispatcher module through the hardware component corresponding to the unicast link and the record playback component. Transmitting the audio-to-be-played from the audio dispatcher module to the broadcast communication module may include transmitting the audio-to-be-played from the audio dispatcher module to the broadcast communication module via an audio hardware module, so as to broadcast the audio-to-be-played through the broadcast communication module. Accordingly, at least one playback device (i.e., broadcast media receiver) can receive the audio-to-be-played. Furthermore, the audio hardware module can send the audio-to-be-played to the communication module controller through the Bluetooth communication module host, so that the communication module controller broadcasts the audio-to-be-played.

In other implementations, the audio-to-be-played may be transmitted directly from the communication module host to the broadcast communication module, so that the broadcast communication module can broadcast the audio-to-be-played to at least one playback device through the broadcast media audio function. In this way, to broadcast the audio-to-be-played, there is no need to transmit the audio-to-be-played to the audio dispatcher module and relay the audio-to-be-played through the audio dispatcher module.

In an optional implementation, the broadcast device can broadcast the audio-to-be-played to at least two playback devices so that the audio-to-be-played can be played synchronously by the two playback devices. That is, in this implementation, the broadcast device makes no sound. The audio-to-be-played is played by the two playback devices that receive the broadcast audio.

The two playback devices may have previously agreed on the same playback delay. Accordingly, the two playback devices receiving the broadcast audio play the audio-to-be-played after a preset period from the time when the broadcast device starts broadcasting the audio-to-be-played. The preset period is equal to the playback delay on which the two playback devices agree. Therefore, the two playback devices synchronously play the audio-to-be-played based on the previously agreed-upon playback delay. This achieves the purpose of synchronously playing the audio-to-be-played through the party mode.

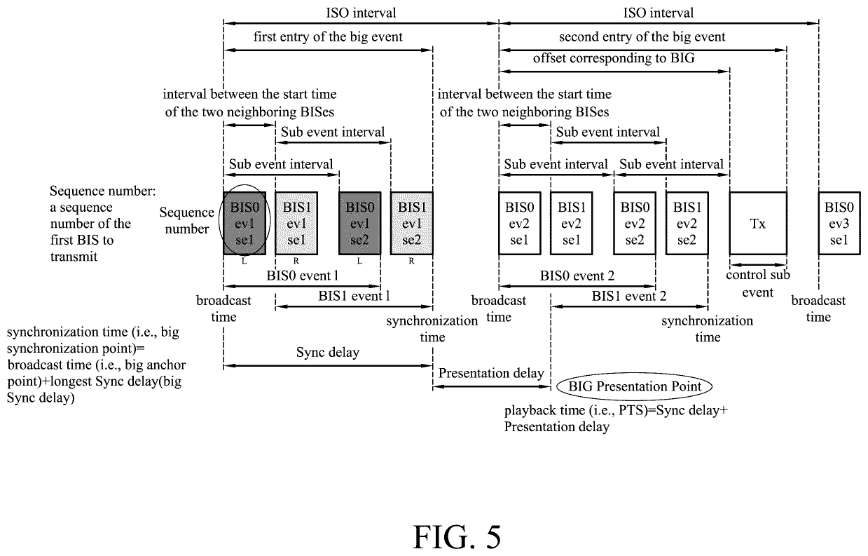

Specifically, as shown in FIG. 5, the two playback devices may agree on the longest Sync delay and the longest Presentation delay. Accordingly, the playback delay on which the two playback devices receiving the broadcast audio agree is the sum of the longest Sync delay and the longest Presentation delay. That is, after “the sum of the longest Sync delay and the longest Presentation delay” from the time when the broadcast device starts broadcasting the audio-to-be-played, the two playback devices play the audio-to-be-played. In this way, a playback time (i.e., PTS) to play the audio-to-be-played may be equal to the sum of the time when the broadcast device starts broadcasting the audio-to-be-played, the longest Sync delay and the longest Presentation delay.

Optionally, the broadcast device and the two playback devices may have agreed on the playback delay during production. Of course, in some embodiments, the broadcast device and the two playback devices may have agreed on the playback delay time after production and before step S102.

Understandably, no matter whether the broadcast device has the function of playing audio, the broadcast device may adopt this implementation to achieve the purpose of playing the audio-to-be-played through the party mode.

In another optional implementation, the broadcast device may broadcast the audio-to-be-played to at least one playback device. The broadcast device plays the audio-to-be-played synchronously with the playback device. That is, in this implementation, the broadcast device also makes a sound. That is, the broadcast device and the playback device that receives the broadcast audio jointly play the audio-to-be-played.

To make the broadcast device easier to play the audio-to-be-played synchronously with the playback device that receives the audio-to-be-played, the broadcast device can first transfer the audio-to-be-played to a playback buffer area before playing the audio-to-be-played. Accordingly, the audio-to-be-played can be played at the corresponding time. This achieves the purpose of synchronously playing the audio-to-be-played through the party mode.

Preferably, in the implementation of the broadcast device transmitting the audio-to-be-played to the broadcast communication module through the audio dispatcher module, the audio dispatcher module can first cache the audio-to-be-played in the playback buffer area after receiving the audio-to-be-played. Then, the audio dispatcher module copies a copy of the audio-to-be-played and transmit it to the broadcast communication module. The playback buffer area can be a buffer area in the audio dispatcher module or outside the audio dispatcher module.

In this implementation, certain measures may be taken to allow the broadcast device and the playback device that receives the broadcast audio to play the audio-to-be-played together.

Optionally, the broadcast device may agree on the same playback delay with the playback device. In this way, the broadcast device and the playback device play the audio-to-be-played after a preset period from the time when the broadcast device start broadcasting the audio-to-be-played. The preset period is the playback delay on which the broadcast device and the playback device agree on. That is, the actual playback time to playback the audio-to-be-played (PTS) is determined based on the original PTS and the preset period. Accordingly, based on the previously agreed-upon playback delay, the broadcast device and the playback device synchronously play the audio-to-be-played. This achieves the purpose of playing the audio-to-be-played through the party mode.

Specifically, the broadcast device and the playback device can agree on the longest Sync delay and the longest Presentation delay. In this way, the playback delay on which the broadcast device and the playback device agree on is the sum of the longest Sync delay and the longest Presentation delay.

In this implementation, when broadcasting the audio-to-be-played through its broadcast communication module, the broadcast device can determine the playback time to play the audio-to-be-played (i.e., actual PTS) based on the time when it starts broadcasting (i.e., original PTS) and the playback delay information. Then, the broadcast device can set the playback time to the audio dispatcher module, so that the audio dispatcher module can know when to play the audio-to-be-played through the playback time.

When setting the playback time to the audio dispatcher module, the broadcast device can also tell the audio dispatcher module the sequence number of the audio-to-be-played. This makes the audio dispatcher module timely send the audio-to-be-played to the playback module based on the sequence number and the playback time.

The playback time is determined by the controller of the broadcast communication module (i.e., BT Controller) based on the time when the broadcast is started and the agreed-upon playback delay. Then, the controller of the broadcast communication module sends the playback time to the audio dispatcher module via a host of the broadcast communication module (i.e., Bluetooth communication module) and a program of the broadcast communication module (i.e., BT App). Specifically, the host of the broadcast communication module sets the playback time to the audio dispatcher module through the program of the broadcast communication module.

Specifically, the controller of the broadcast communication module can determine the playback time through the LE audio spec algorithm.

In the case of multiple frames of audio, the broadcast device can determine the playback time of the first frame of the audio-to-be-played based on the time when it broadcasts the first frame of the audio-to-be-played and the playback delay information. Then, the broadcast device can set the playback time of the first frame of the audio-to-be-played to the audio dispatcher module. In this way, the audio dispatcher module can know when to play the first frame of the audio-to-be-played through the playback time of the first frame of the audio-to-be-played. Then, the audio dispatcher module controls the playback module to play the first frame of the audio-to-be-played at the corresponding time. Subsequently, the playback modules plays the non-first frames of the audio-to-be-played in order. This achieves playing multiple frames of the audio-to-be-played synchronously on the broadcast device and on the playback device receiving the audio-to-be-played.

In this embodiment, a unicast data-receiving function and a BMS function are integrated in the broadcast device. The unicast data-receiving function receives the audio data from the source device via a unicast link. Then, the BMS function broadcasts the audio data. In this way, through BMS-BMR, the party mode is implemented between the broadcast device and the playback device receiving the broadcast data. Accordingly, end devices such as mobile phones and laptops that only support traditional unicast functions can also apply the party mode function of the playback device and keep the audio-to-be-played played synchronously.

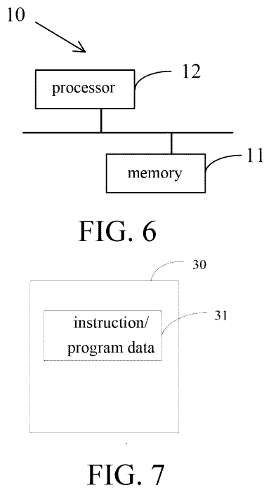

Please refer to FIG. 6. FIG. 6 is a schematic diagram of the structure of the broadcast device of an embodiment of the present application. The broadcast device 10 includes a processor 12. The processor 12 is configured to execute instructions to implement the above audio playback method. The specific implementation steps can be found in the description of the above embodiment, which will not be repeated here.

The processor 12 may also be called a Central Processing Unit (CPU). The processor 12 may be an integrated circuit chip with signal processing capabilities. The processor 12 may also be a general-purpose processor, a digital signal processor (DSP), an application-specific integrated circuit (ASIC), a field programmable gate array (FPGA) or other programmable logic devices, discrete gate or transistor logic devices, discrete hardware components. A general-purpose processor may be a microprocessor. The processor 12 may also be any conventional processor, etc.

The broadcast device 10 may further include a memory 11 for storing instructions and data required for the processor 12 to run.

The processor 12 is configured to execute instructions to implement the method provided by any embodiment of the audio playback method of the present application and any non-conflicting combination.

Please refer to FIG. 7. FIG. 7 is a schematic diagram of the structure of a computer-readable storage medium in an embodiment of the present application. The computer-readable storage medium 30 of the embodiment of the present application stores instruction/program data 31. When the instruction/program data 31 are executed, the method provided by any embodiment of the audio playback method of the present application and any non-conflicting combination is implemented. The instruction/program data 31 can form a program file and be stored in the above-mentioned storage medium 30 in the form of a software product. Therefore, a computer device (e.g., a personal computer, a server, or a network device, etc.) or a processor executes all or part of the steps of each embodiment method of the present application. The aforementioned storage medium 30 includes: various media that can store program codes, e.g., a USB flash drive, a mobile hard disk, a read-only memory (ROM), a random access memory (RAM,), a disk or an optical disk, or an end device such as a computer, a server, a mobile phone, and a tablet.

In the several embodiments provided in the present application, it should be understood that the disclosed systems, devices and methods can be implemented in other ways. For example, the device embodiments described above are only schematic. For example, the division of units is only a logical function division. There may be other division methods in actual implementation. For example, multiple units or components can be combined or integrated into another system, or some features can be ignored or not executed. Another point is that the mutual coupling or direct coupling or communication connection shown or discussed can be an indirect coupling or communication connection through some interfaces, devices or units, which can be electrical, mechanical or other forms.

In addition, each functional unit in each embodiment of the present application may be integrated into one processing unit. Alternatively, each unit may exist physically separately, or two or more units may be integrated into one unit. The above-mentioned integrated unit may be implemented in the form of hardware or in the form of software functional units.

It should also be noted that the terms “include”, “comprises” or any other variations thereof are intended to cover non-exclusive inclusion. Therefore, a process, method, commodity or device including a series of elements includes not only those elements, but also other elements not explicitly listed, or also includes elements inherent to such process, method, commodity or device. In the absence of more restrictions, the elements defined by the sentence “comprises a . . . ” do not exclude the existence of other identical elements in the process, method, commodity or device including the elements.

The above are only embodiments of the present application, and are not intended to limit the patent scope of the present application. Any equivalent structure or equivalent process transformation made using the contents of the present application specification and drawings, or directly or indirectly applied in other related technical fields, are also included in the patent protection scope of the present application.

What is claimed is:

1. An audio playback method, comprising:
a broadcast device obtaining audio-to-be-played from a source device via a unicast link; and
when indicated by the source device to apply a party mode to play the audio-to-be-played, the broadcast device serving as a broadcast media sender and broadcasting the audio-to-be-played to at least one playback device, so as to play the audio-to-be-played through the at least one playback device.

2. The audio playback method as claimed in claim 1, wherein the broadcast device serving as the broadcast media sender and broadcasting the audio-to-be-played to the at least one playback device, so as to play the audio-to-be-played through the at least one playback device, comprises:
the broadcast device serving as the broadcast media sender and broadcasting the audio-to-be-played to the at least one playback device, so as to play the audio-to-be-played synchronously through the broadcast device and the at least one playback device.

3. The audio playback method as claimed in claim 1, wherein the broadcast device serving as the broadcast media sender and broadcasting the audio-to-be-played to the at least one playback device, so as to play the audio-to-be-played synchronously through the broadcast device and the at least one playback device, comprises:
the broadcast device and the at least one playback device playing the audio-to-be-played after a preset period from a time when the broadcast device starts broadcasting the audio-to-be-played;
wherein the preset time is a playback delay which the broadcast device and the at least one playback device have previously agreed on.

4. The audio playback method as claimed in claim 3, wherein the broadcast device comprises a unicast communication module and an audio dispatcher, wherein the broadcast device serving as the broadcast media sender and broadcasting the audio-to-be-played to the at least one playback device, so as to play the audio-to-be-played synchronously through the broadcast device and the at least one playback device, comprises:
the unicast communication module transmitting the audio-to-be-played to the audio dispatcher; and
the audio dispatcher caching the audio-to-be-played, so as to play the audio-to-be-played after the preset period from the time when the broadcast device starts broadcasting the audio-to-be-played.

5. The audio playback method as claimed in claim 4, wherein the broadcast device comprises a playback module, wherein the broadcast device serving as the broadcast media sender and broadcasting the audio-to-be-played to the at least one playback device, so as to play the audio-to-be-played synchronously through the broadcast device and the at least one playback device, comprises:
the broadcast device determining a playback time for the at least one playback device to play the audio-to-be-played based on the time when the broadcast device starts broadcasting the audio-to-be-played and the playback delay;
the broadcast device setting the playback time to the audio dispatcher module, so as to make the audio dispatcher module play the audio-to-be-played at the playback time.

6. The audio playback method as claimed in claim 4, wherein the broadcast device comprises a broadcast communication module, wherein after the unicast communication module transmitting the audio-to-be-played to the audio dispatcher, the audio playback method further comprises:
the audio dispatcher module copying the audio-to-be-played and transmitting the audio-to-be-played to the broadcast communication module, so as to make the broadcast communication module broadcast the audio-to-be-played to the at least one playback device.

7. The audio playback method as claimed in claim 1, wherein the broadcast device comprises a Bluetooth communication module, wherein the Bluetooth communication module comprises a broadcast communication module and a unicast communication module;
wherein the broadcast device obtaining the audio-to-be-played from the source device via the unicast link comprises the unicast communication module obtaining the audio-to-be-played via the unicast link;
wherein when indicated by the source device to apply the party mode to play the audio-to-be-played, the broadcast device serving as the broadcast media sender and broadcasting the audio-to-be-played to the at least one playback device, so as to play the audio-to-be-played through the at least one playback device, comprises:
in the Bluetooth communication module, the unicast communication module sending the audio-to-be-played to the broadcast communication module, so as to make the broadcast media module broadcast the audio-to-be-played to the at least one playback device using a broadcast media sender function.

8. The audio playback method as claimed in claim 7, wherein the unicast link is an A2DP link.

9. The audio playback method as claimed in claim 1, wherein the broadcast device serving as the broadcast media sender and broadcasting the audio-to-be-played to the at least one playback device, so as to play the audio-to-be-played through the at least one playback device, comprises:
the broadcast device serving as the broadcast media sender and broadcasting the audio-to-be-played to at least two playback devices, so as to play the audio-to-be-played synchronously through the at least two playback devices.

10. A broadcast device, comprising a memory and a processor that are coupled to each other, wherein the processor is configured to execute a program instruction stored in the memory, so as to implement the audio playback method as claimed in claim 1.

11. A computer-readable storage medium, comprising instruction/program data, wherein the instruction/program data implement the audio playback method as claimed in claim 1 when executed.
